(19) United States
(12) Patent Application Publication
(10) Pub. No.: US 2022/0137633 A1
(43) Pub. Date: May 5, 2022

(54) METHOD FOR AN ONLINE CALIBRATION, AND CALIBRATION DEVICE

(71) Applicant: ZF Friedrichshafen AG, Friedrichshafen (DE)

(72) Inventors: Zhihu CHEN, Konstanz (DE); Marcus HIEMER, Meckenbeuren (DE)

(21) Appl. No.: 17/430,514

(22) PCT Filed: Feb. 10, 2020
(86) PCT No.: PCT/EP2020/053267

§ 371 Date: Aug. 12, 2021

(30) Foreign Application Priority Data
Feb. 20, 2019 (DE) 10 2019 202 299.5

(51) Int. Cl. G05D 1/02; G06V 20/10; G06V 20/56

(52) U.S. Cl. CPC G05D 1/0219; G05D 2201/0201; G06V 20/56; G06V 20/188

(57) ABSTRACT

A method for online calibration of an environment detection system (12) of an agricultural utility vehicle (10). The method is carried out during operation of the agricultural utility vehicle (10). During a first step, the environment detection system (12) detects the current environment of the agricultural utility vehicle (10). During a further step, current extrinsic calibration parameters are determined on the basis of the current environment (20) detected. Furthermore, a calibration device (14) for carrying out the method and an agricultural utility vehicle (10) with such a calibration device (14) are also described.

This application is a National Stage completion of PCT/EP2020/053267 filed Feb. 10, 2020, which claims priority from German patent application serial no. 10 2019 202 299.5 filed Feb. 20, 2019.

### FIELD OF THE INVENTION

The invention relates to a method for an online calibration of an environment detection system of an agricultural utility vehicle. The invention also relates to a calibration device for carrying out a method of the said type and to an agricultural utility vehicle with such a calibration device.

### BACKGROUND OF THE INVENTION

It is known to provide sensors on an agricultural utility vehicle in order to detect the environment of the agricultural utility vehicle. The sensors can be provided at various positions on the agricultural utility vehicle and can be orientated in various directions.

DE 10 2015 119 078 A1 describes a control system for an agricultural machine, which envisages the calibration of sensors. For the sensor calibration, sensor-specific correction values are calculated, which are then taken into account during the operation of the agricultural machine.

### SUMMARY OF THE INVENTION

In one aspect the present invention relates to a method for the online calibration of an environment detection system of an agricultural utility vehicle. With the method, a sensor of the environment detection system can be calibrated online.

The environment detection system can be installed on the agricultural utility vehicle. The environment detection system can comprise image-forming and/or distance-measuring sensor systems. With the image-forming sensors, images of the current environment of the agricultural utility vehicle can be detected. With the distance-measuring sensors point clouds that relate to objects permanently in the environment of the agricultural utility vehicle can be produced.

The environment detection system can comprise at least two sensors. The at least two sensors can comprise, in any desired combination, at least two of at least a camera, at least a laser scanner, at least a radar unit and at least an ultrasound sensor. The at least two sensors can be arranged with various orientations on the agricultural utility vehicle. Alternatively or in addition, the at least two sensors can have various or variously arranged detection ranges. Alternatively or in addition, the at least two sensors can be arranged in various positions on the agricultural utility vehicle. A relative position of the two sensors, in relation to one another, can change during the operation of the agricultural utility vehicle. In addition, an absolute position of the two sensors can change during the operation of the agricultural utility vehicle.

The online calibration of the environment detection system can comprise an online determination of calibration parameters of the environment detection system. The online calibration can be carried out as an extrinsic calibration of the environment detection system. The online calibration can comprise a dynamic calibration of the environment detection system. In other words, extrinsic calibration parameters of the environment detection system can be determined. Then, a relative position or an extrinsic position of at least two sensors of the environment detection system relative to one another can be determined. In addition, an absolute position of the at least two sensors of the environment detection system can be determined. In contrast, intrinsic calibration parameters can be determined in advance.

The agricultural utility vehicle can be a vehicle designed to cultivate an agriculturally useful area. The agricultural utility vehicle can be, for example, a tractor or an agricultural sprayer. The agricultural utility vehicle can further be designed as an autonomous vehicle or a vehicle that can be operated autonomously. Thus, the method for automated online calibration of an environment detection system can also be implemented with an agricultural utility vehicle that can be operated in an automated manner.

The steps of the method are carried out during the operation of the agricultural utility vehicle. Thus, the steps of the method can be carried out during driving operation or during working operation. In other words, steps of the method can be carried out while the agricultural utility vehicle is driving. The method can be carried out when the agricultural utility vehicle is on an agriculturally useful area and is being used for work. The agricultural utility vehicle can be stopped in order to carry out at least one of the steps. Alternatively or in addition, the agricultural utility vehicle can be moving during at least one of the steps to be carried out.

In an initial step, the operation of the agricultural utility vehicle can be started. After the agricultural utility vehicle has started operating, the method can then be carried out. Once the vehicle and its environment detection system have started operating, the rest of the steps can be carried out.

A first step to be carried out during the operation of the agricultural utility vehicle is to detect the current environment of the agricultural utility vehicle by means of the environment detection system.

The current environment of the agricultural utility vehicle can at least comprise an area of a current environment of an agriculturally useful area. The current environment or current surroundings can include objects, which can be detected by the environment detection system. The objects can be natural or synthetic objects. Objects that can be natural ones may be ground areas or vegetation areas in the agriculturally useful area. Objects that can be synthetic ones may be building works on the agriculturally useful area. Thus for example, working borders or cut edges in a field and/or building works can be detected by the environment detection system. The step of detection can include the detection of linear objects in the current environment of the agricultural utility vehicle. A linear object can be, for example, a track or a border.

A further step to be carried out during the operation of the agricultural utility vehicle comprises the determination of current extrinsic calibration parameters on the basis of the detected current environment for an online calibration of the environment detection system.

The current extrinsic calibration parameters can relate to a current relative position of at least two sensors of the environment detection system. In addition, the current extrinsic calibration parameters can relate to an absolute position of at least one of the sensors of the environment detection system. The current extrinsic calibration parameters can comprise relative calibration parameters and/or external calibration parameters.

The current extrinsic calibration parameters can change during the operation of the agricultural utility vehicle. In other words, a change of inconstant extrinsic calibration parameters, during the operation of the agricultural utility vehicle, is determined in the step of determination and taken into account in an online calibration. The determination step can be carrier out on the basis of objects detected in the current environment of the agricultural utility vehicle.

The steps to be carried out, during the operation of the agricultural utility vehicle, can be carried out continuously. Thus, the online calibration can be carried out as a continuous calibration or constant calibration of the environment detection system during the operation of the agricultural utility vehicle on an agriculturally useful area. In contrast to an off-line calibration before the operation of the agricultural utility vehicle, in that way changing operational influences on the environment detection system can be taken into account during the operation of the agricultural utility vehicle.

Thus, variable relative positions, of at least two sensors of the environment detection system, can be taken into account during the operation of the agricultural utility vehicle. In addition, a variable absolute position, of at least one sensor of the environment detection system, can also be taken into account during the operation of the agricultural utility vehicle. Thus, the method can implement a robust online calibration process.

A changing relative position, of at least two sensors of the environment detection system, can involve a changing distance between the at least two sensors and/or a changing relative direction or orientation of the two sensors relative to one another. A changing absolute position of at least one sensor of the environment detection system can include a changing absolute orientation of the said at least one sensor. The absolute orientation can be an orientation of the at least one sensor relative to a vertical or horizontal spatial direction. In other words, changing positions of at least two environment detection system sensors can be taken into account.

The agricultural utility vehicle can comprise an agricultural implement. The environment detection system can be installed on the agricultural utility vehicle and/or on an agricultural implement attached to the agricultural utility vehicle. Sensors and environment detection systems can be correspondingly fitted on the agricultural utility vehicle and/or on the agricultural implement attached thereto.

With the method it is therefore advantageously possible, during the operation of the agricultural utility vehicle, to take into account loads that occur and vary on it which can result in a changing relative position and/or absolute position of sensors of the environment detection system. The said loads can be, for example, weight loads, traction loads and/or pressure loads. These loads can result in the changing relative position of the sensors. If the agricultural utility vehicle is a sprayer, a decreasing quantity of water in a tank of the sprayer can result in changing loads on it during the operation of the sprayer. These changing loads can result in the changing relative and/or absolute positions of the sensors of the environment detection system. Water ejection through nozzles of the sprayer, when the sprayer has begun operating, can also result in the consequences described.

Furthermore, with the method it is advantageously possible, during the operation of the agricultural utility vehicle, to take account of vibrations or temperature fluctuations which can also result in changing relative and/or absolute positions of sensors of the environment detection system.

Moreover, at least two sensors of the environment detection system can be fitted onto components of the agricultural utility vehicle and/or the agricultural implement. During the operation of the agricultural utility vehicle, the said components can move relative to one another, whereby the relative position of the sensors can change. For example, the height of individual components, a vehicle frame and/or a vehicle chassis can be adjustable, whereby a relative distance of the sensors of the environment detection system from a reference point or a reference line on the agricultural utility vehicle or on the agriculturally useful area can change. The reference line can be defined by a wheel axle, for example by a rear axle of the agricultural utility vehicle. In a further step of the method, such distances can be determined on the basis of the detected surroundings of the environment detection system.

According to an embodiment of the method, the detection step includes the detection of geometrical features in the current surroundings of the agricultural utility vehicle. The objects in the surroundings of the agricultural utility vehicle can include such geometrical features. The geometrical features can be vectors and/or lines of objects in the current environment of the agricultural utility vehicle. For example, a normal vector of a surface of an object, a boundary line between two objects or a line of symmetry of an object can be detected. The normal vector can be derived from a point cloud or from a plurality of points measured on a surface of an object. A line of symmetry can be, for example, derived from a detected cylindrical object. Alternatively or in addition, the geometrical features can comprise points. Thus, from a detected spherical object its mid-point can be derived, for example.

By the detection of geometrical features or parameters of objects in the current environment of the agricultural utility vehicle, the actual environment can be more reliably and accurately detected. If the geometrical features are detected by at least two sensors of the environment detection system, from these their relative position and thus their current extrinsic calibration parameters can be determined. For this, methods from Computer Vision, for example from perspective projection, can be applied.

According to the above embodiment, the step of determining current extrinsic calibration parameters can be carried out on the basis of the detected geometrical features. Thus, the current extrinsic calibration parameters can be determined from redundantly detected objects, i.e., objects detected by at least two sensors of the environment detection system.

A further embodiment of the method includes, as another step to be carried out during the operation of the agricultural utility vehicle, an extraction of linear features from the detected current environment. The linear features can include vectors and/or lines of objects in the current environment. The linear features can comprise geometrical parameters of straight lines. The linear features can also comprise geometrical parameters of curved lines, for example circular arcs and/or splines. The extraction step can involve an extraction of lines in an image of the current environment or in a point cloud of the current environment. Lines can be determined by curve-fitting methods. Parameters of a line can, therefore, be parameters of a mathematically overdetermined estimated line.

According to this embodiment, the step of determining can be carried out on the basis of the extracted linear features. Lines extracted from the measurement data of at least two sensors of the environment detection system can be superimposed in order to deduce the position of the at least two sensors relative to one another. In other words, the position of sensor co-ordinate systems of the at least two sensors, relative to one another, can be determined. The current extrinsic calibration parameters can, therefore, correspond to current transformation parameters between sensor co-ordinate systems of the environment detection system.

Thus, an advantage of the method can be that current extrinsic calibration parameters or current transformation parameters can be determined based on objects, i.e., based only on objects in the surroundings of the agricultural utility vehicle. For this it may not be necessary to have recourse to measurement targets or pass-points in the environment of the agricultural utility vehicle and to detect them specifically by the environment detection system. In other words, in this way, with the method the environment detection system can be operated already on the basis of objects, in any case, already present in the environment of the agricultural utility vehicle.

A further embodiment of the method comprises, as another step to be carried out during the operation of the agricultural utility vehicle, a determination of a future trajectory of the agricultural utility vehicle. The future trajectory can be a route to be covered by the agricultural utility vehicle at a future time. The future trajectory can be specified, or derived from the current environment of the agricultural utility vehicle. Furthermore, the future trajectory can be determined on the basis of a localization or positioning of the agricultural utility vehicle. On the basis of a current position of the agricultural utility vehicle, the route can be pre-calculated. The determination can thus include the planning of a future route. The determined future trajectory can also be determined on the basis of map information about the surroundings of the agricultural utility vehicle. The future trajectory can be chosen by a driver of the agricultural utility vehicle, or specified by an assistance system of the agricultural utility vehicle.

According to this embodiment, as a further step to be carried out during the operation of the agricultural utility vehicle, a curvature of the established future trajectory can be determined. The determination of the curvature can include a determination of a future curve radius. Alternatively or in addition, the determination of the curvature can involve a deduction of the curvature from a steering angle specification.

Furthermore, in this embodiment, the step of determining current extrinsic calibration parameters can be carried out as a function of the determined curvature. The online calibration of the environment detection system can, therefore, be carried out as a function of the curvature of a future trajectory of the agricultural utility vehicle. In this way, influences of driving round a curve on the relative positions of sensors of the environment detection system can be allowed for.

A further embodiment of the method comprises, as a further step to be carried out during the operation of the agricultural utility vehicle, a check to see whether the curvature of the determined future trajectory is less than a predefined curvature limit value. In this embodiment, the step of determining current extrinsic calibration parameters can be carried out if the determined curvature is less than the predefined curvature limit value. Thus, in an advantageous manner it can be checked whether the future route of the agricultural utility vehicle is suitable for the online calibration of the environment detection system.

If the curvature of the future trajectory is less than the predefined curvature limit value or if it has a curve radius larger than a predefined curve radius, the future trajectory can be suitable for online calibration. On the other hand, if the curvature of the future trajectory is tighter than the predefined curvature limit value or if it has a smaller radius of curvature than a predefined radius of curvature, the future trajectory may not be suitable for online calibration.

Thus, the online calibration can be carried out when the curvature of the future trajectory is less than the predefined curvature limit value. In contrast, online calibration cannot be carried out if the curvature of the future trajectory is greater than the predefined curvature limit value. Detectable geometrical features and extractable linear features can also be correlated with, or can condition the curvature of the future trajectory. Thus, for example, straight wheel-ruts or driving lines or work borders, such as cut edges in the driving direction, are more likely to be ahead of the agricultural utility vehicle if the future trajectory contains a straight trajectory section.

A further embodiment of the method comprises, as a further step to be carried out during the operation of the agricultural utility vehicle, the determination of a quality parameter of the extracted linear features. The quality parameter can describe the reliability, the precision and/or the completeness of a detection of a geometrical feature and/or an extracted linear feature. Thus, the quality parameter can comprise, for example, a measure of the scatter of measurement points along an extracted line. Moreover, the quality parameter can specify a measures of how long an extracted line is and/or whether the extracted line has intervals in which there are no measurement points. The quality parameter of the extracted linear feature can be derived from a calculation of the linear feature, or determined directly. The quality parameter can relate to a straight line or a curved line. For example, the quality parameter can even describe the reliability or precision of a parameter for a polynomial, which can be extracted as a line.

According to the above embodiment, as a further step during the operation of the agricultural utility vehicle, it can be checked whether the determined quality parameter is larger than a predefined quality limit value. In the above embodiment, the step of determining current extrinsic calibration parameters can be carried out if the determined quality parameter is larger than the predefined quality limit value. In other words, an extracted linear feature can be used for the determination of current extrinsic parameters if it could be determined with sufficient geometrical or stochastic reliability. In that way, the precision of the current extrinsic calibration parameters determined and, hence also the precision of the online calibration, can be increased.

According to a further embodiment of the method, the agricultural utility vehicle comprises an agricultural implement. The agricultural implement can be moved by the agricultural utility vehicle during the operation of the agricultural utility vehicle. The agricultural implement can also be provided in the form of an attachment to the agricultural utility vehicle. The agricultural implement can be moved relative to the agricultural utility vehicle during the operation of the agricultural utility vehicle. Thereby, the position of the agricultural implement relative to the agricultural utility vehicle can change.

In the above embodiment, the environment detection system can comprise at least one sensor arranged on the agricultural implement. If the agricultural implement moves relative to the utility vehicle or conversely, current extrinsic calibration parameters can be determined taking account of such position changes. If a further sensor of the environment detection system is arranged on the agricultural utility vehicle, a relative position change between these two sensors can be taken into account by a recalibration.

According to a further embodiment, the environment detection system can comprise at least two sensors which are arranged on the agricultural implement. The at least two sensors can be fitted onto various components of the agricultural implement, which can be moved relative to one another. If the components move relative to one another, current extrinsic calibration parameters can be determined taking into account such positional variations.

In a further embodiment of the method, the steps to be carried out during the operation of the agricultural utility vehicle are carried out during the automated travel of the agricultural utility vehicle. The automated travel of the agricultural utility vehicle can be remotely controlled. Thus, the method can also be carried out for the remotely controlled online calibration of an environment detection system of the agricultural utility vehicle. The operation of the agricultural utility vehicle for so-termed “precision farming” can, therefore, be carried out with a higher level of automation. Advantageously, the calibration of the agricultural utility vehicle can be carried out “on the fly” using the method in the agricultural utility vehicle. Thus, the online calibration can be carried out on the agricultural utility vehicle on the spot without intervention by a user.

According to a further aspect of the invention, a calibration device is disclosed. The calibration device is designed to carry out the steps of the method in accordance with the preceding aspect. The calibration device can be installed on an agricultural utility vehicle.

The calibration device can comprise interfaces for reading in detection data of a current environment of the agricultural utility vehicle. The calibration device can comprise at least two sensors for producing such detection data. The calibration device can comprise, for example, at least two cameras, at least two laser scanners, at least two radar units and/or at least two ultrasonic sensors. The calibration device can also comprise at least two different sensors, for example a camera and a laser scanner. The calibration device can also comprise a determination unit for determining current extrinsic calibration parameters on the basis of the detection data read in or detected.

The calibration device can also comprise a localization component for the localization of the agricultural utility vehicle. In addition, the calibration device can comprise a route planning component for planning a future route to be travelled on the basis of the localization.

In a further aspect, the invention relates to an agricultural utility vehicle with a calibration device according to the preceding aspect.

### BRIEF DESCRIPTION OF THE DRAWINGS

FIG. 1: shows an agricultural utility vehicle with a calibration device according to a respective embodiment.

FIG. 2: shows a flow chart with process steps for carrying out a method for online calibration of an environment detection system of the agricultural utility vehicle, in accordance with an embodiment of the invention.

FIG. 3: shows the utility vehicle on an agriculturally useful area after beginning to operate, in order to explain the method.

FIG. 4: shows the agricultural utility vehicle after it has processed part of the agriculturally useful area, in order to further explain the method.

FIG. 5: shows the agricultural utility vehicle after a turning maneuver before further processing of another part of the agriculturally useful area, in order to further explain the method.

### DETAILED DESCRIPTION OF THE PREFERRED EMBODIMENTS

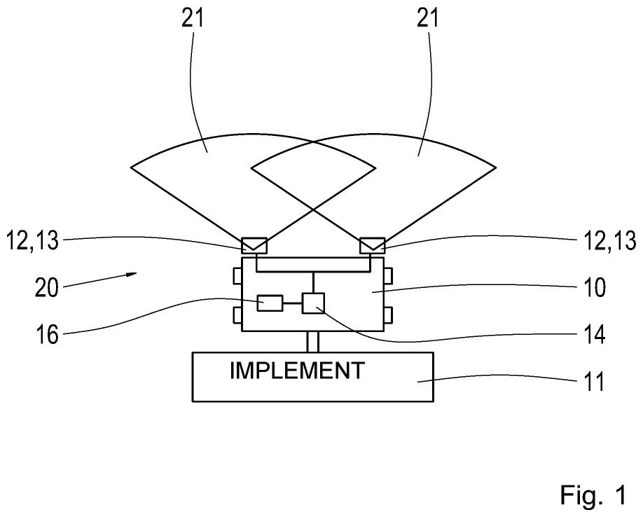

FIG. 1 shows an agricultural utility vehicle 10 with an agricultural implement 11 installed on it. In this embodiment the agricultural implement 11 is coupled to a rear area of the agricultural utility vehicle 10.

Two environment detection sensors 13 are arranged at a front area of the agricultural utility vehicle 10. The environment detection sensors 13 form the environment detection system 12 of the agricultural utility vehicle 10. The two environment detection sensors 13 have respective detection ranges 21 which, in this embodiment, are directed in the travel direction of the agricultural utility vehicle 10. The detection ranges 21 cover a partial area of an environment 20 around the agricultural utility vehicle 10. The detection ranges 21 partially overlap. Alternatively or in addition to the embodiment shown in FIG. 1, the environment detection sensors 13 can be arranged at least partially on the agricultural implement 11. In a further embodiment (not shown in FIG. 1), one environment detection sensor 13 is arranged on the agricultural utility vehicle 10 and one is arranged on the agricultural implement 11.

In addition, a positioning device 16 and a calibration device 14, which are connected to one another, are arranged on the agricultural utility vehicle 10. The positioning device 16 is designed to determine a current position of the agricultural utility vehicle 10. The calibration device 14 is also connected to the two environment detection sensors 13 of the environment detection system 12, in order to read out their detection data and, on the basis thereof, to determine extrinsic calibration parameters of the two environment detection sensors 13 of the environment detection system 12.

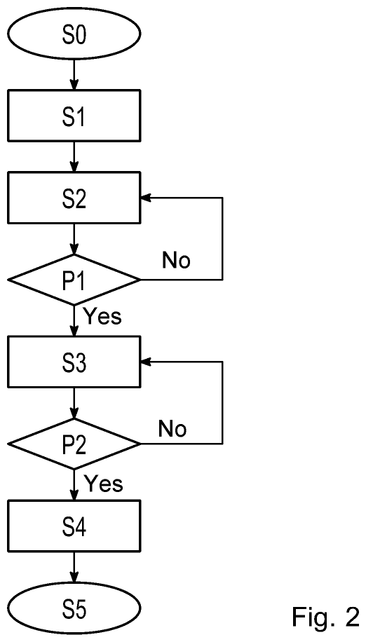

FIG. 2 shows process steps for carrying out a method for the online calibration of the environment detection system 12 of the agricultural utility vehicle 10 shown in FIG. 1. The method is carried out during an operation of the agricultural utility vehicle 10.

In an initial process step S0, the agricultural utility vehicle 10 begins operating. When beginning its operation, at least one machine (not shown in the figures) of the agricultural utility vehicle 10 is started.

In a first process step S1 a localization of the agricultural utility vehicle 10 in its environment takes place. In this localization step, a current position of the agricultural utility vehicle 10 is determined.

On the basis of the position of the agricultural utility vehicle 10 determined in the first process step S1, in a second process step S2 a future trajectory of the agricultural utility vehicle 10 is determined. The future trajectory is determined in order to process an agriculturally useful area by means of the agricultural utility vehicle 10.

In a subsequent first checking step P1, it is checked whether the future trajectory determined in the second process step S2 is suitable for carrying out an online calibration of the environment detection system 12. As a decision criterion of the first checking step P1, a curvature of the future trajectory determined is considered. If this curvature is less than a predetermined curvature limit value, a further subsequent process step S3 is carried out. If the curvature of the future trajectory is greater than the predetermined curvature limit value, the previous second process step S2 of trajectory determination is again carried out at a later time. At this later time the agricultural utility vehicle 10 will have moved farther along the future trajectory. The second process step S2 and the first checking step P1 are repeated until the decision criterion of the first checking step P1 is fulfilled.

When the decision criterion of the first checking step P1 is fulfilled, the third process step S3 is carried out. In this third process step S3, the environment 20 is detected by means of the environment detection system 12 arranged on the agricultural utility vehicle 10, i.e., by means of the environment detecting sensors 13. In this step geometrical features in the environment 20 of the agricultural utility vehicle 10 are detected by the environment detection system 12.

In a second checking step P2, a quality check of the lines detected in the preceding third process step S3 takes place. As the decision criterion of this second checking step P2, a reliability value of one of the geometrical parameters of the lines is used. If this reliability value is above a predefined reliability limit value, the method goes on to a further process step S4. If the reliability is lower than the predetermined reliability limit value, the preceding third process step S3 is repeated. The second checking step P2 and the third process step S3 are repeated until the decision criterion of the second checking step P2 is fulfilled.

In a fourth process step S4, a calibration parameter determination takes place. In this step, current extrinsic calibration parameters of the environment detection sensors 13 of the environment detection system 12 are determined on the basis of the geometrical features detected in the third process step S3. On the basis of the extrinsic calibration parameters determined in the fourth process step S4, in a further fifth process step S5, an online calibration of the environment detection sensors 13 of the environment detection system 12 is carried out.

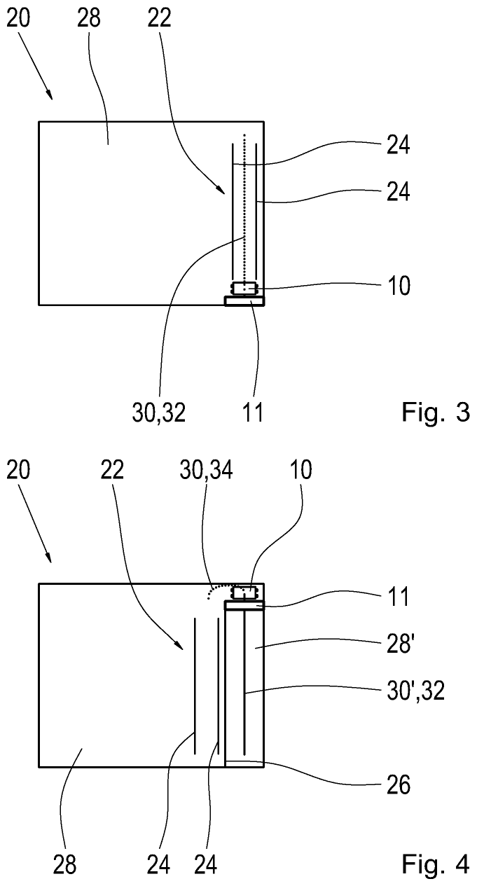

In FIG. 3, the agricultural utility vehicle 10, with the agricultural implement 11, is shown on an unprocessed agriculturally useful area 28. The environment 20 of the agricultural utility vehicle 10 contains, at least in part, the unprocessed agriculturally useful area 28. Geometrical features 22 of the agriculturally useful area 28 are in the travel direction ahead of the agricultural utility vehicle 10. The geometrical features 22 on the unprocessed agriculturally useful area 28 consist of two wheel-ruts 24.

The wheel-ruts 24 are detected, in the third process step S3, by the environment detection system 12 (not shown in FIGS. 3 to 5). A future trajectory 30, which was determined in the second process step S2, is in the form of a straight trajectory 32. The wheel-ruts 24 are used for determining the current extrinsic calibration parameters of the environment detection sensors 13 of the environment detection system 12 in the fourth process step S4, since the future trajectory 30 is a straight trajectory 32.

In FIG. 4, the agricultural utility vehicle 10, with its agricultural implement 11, is shown at a later time during the processing of the agriculturally useful area 28. Behind the agricultural utility vehicle 10, relative to the travel direction, now there is a processed agriculturally useful area 28′. Since the vehicle is at the edge of the agriculturally useful area 28, after having driven over the already covered trajectory 30′, it must now carry out a turning maneuver. The future trajectory 30 to be covered for that is now a curved trajectory 34. Further wheel-ruts 24 are now not used for determining the current extrinsic calibration parameters of the environment detection sensors 13 of the environment detection system 12 in the fourth process step S4, since the future trajectory 30 is a curved trajectory 34.

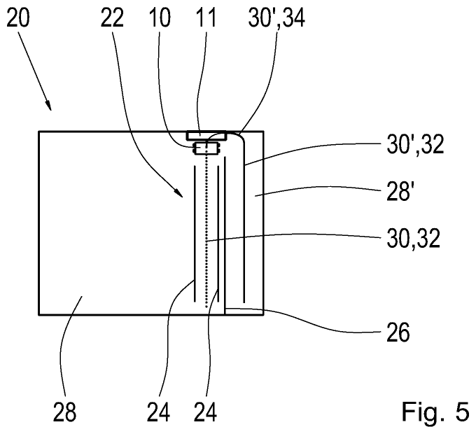

In FIG. 5, the agricultural utility vehicle 10 with its agricultural implement 11 is shown after having driven over the curved trajectory 34, shown in FIG. 4, as the trajectory 30′ covered. Now in the travel direction ahead of the agricultural utility vehicle 10 there is, besides the further wheel-ruts 24, also a work boundary 26 between the previously processed agriculturally useful area 28′ and the still unprocessed agriculturally useful area 28. Analogously to what was described with reference to FIG. 3, besides the wheel-ruts 24, the agricultural utility vehicle 10 now also detects, with its environment detection system 12, the work boundary 26. From the detected wheel-ruts 24 and the work boundary 26, further linear features are derived, which are now used for determining current extrinsic calibration parameters.

### INDEXES

10 Agricultural utility vehicle
11 Agricultural implement
12 Environment detection system
13 Environment detection sensor
14 Calibration device
16 Positioning device
20 Environment
21 Detection range
22 Geometrical features
24 Wheel-rut
26 Work boundary
28 Agriculturally useful area
28′ Processed agriculturally useful area
30 Future trajectory
30′ Trajectory covered
32 Straight trajectory
34 Curved trajectory
P1 Curvature check
P2 Quality check
S0 Start of operation
S1 Localization
S2 Trajectory determination
S3 Environment detection
S4 Calibration parameter determination
S5 Online calibration

1-10. (canceled)

11. A method for online calibration of an environment detection system (12) of an agricultural utility vehicle (10), the method comprising the following steps to be carried out during the operation of the agricultural utility vehicle (10):
detecting (S3) a current environment (20) of the agricultural utility vehicle (10) by the environment detection system (12); and
determining (S4) current extrinsic calibration parameters, on a basis of the detected current environment (20), for an online calibration (S5) of the environment detection system (12).

12. The method according to claim 10, further comprising:
detecting geometrical features (22) during the detecting step (S3) of the current environment (20) of the agricultural utility vehicle (10), and
carrying out the determinating step (S4) on a basis of the detected geometrical features (22).

13. The method according to claim 10, further comprising:
extracting linear features (24, 26) from the detected current environment (20), and
carrying out the determinating step (S4) on a basis of the extracted linear features (24, 26).

14. The method according to claim 10, further comprising:
determinating (S2) a future trajectory (30) of the agricultural utility vehicle (10),
determining a curvature of the determined future trajectory (30), and
carrying out the determinating step (S4) of current extrinsic calibration parameters as a function of the determined curvature.

15. The method according to claim 14, further comprising:
checking (P1) whether the curvature of the determined future trajectory (30) is less than a predefined curvature limit value, and
if the curvature determined is less than the predefined curvature limit value, carrying out the determination step (S4) of current extrinsic calibration parameters.

16. The method according to claim 13, further comprising:
determinating a quality parameter of the extracted linear features (24, 26), and
checking (P2) whether the determined quality parameter is larger than a predefined quality limit value, and
if the quality parameter determined is larger than the predefined quality limit value, carrying out the determinating step (S4) of current extrinsic calibration parameters.

17. The method according to claim 10, further comprising:
providing the agricultural utility vehicle (10) with an agricultural implement (11), and the environment detection system (12) having at least one sensor fitted on the agricultural implement (11).

18. The method according to claim 10, carrying out the steps during automated travel of the agricultural utility vehicle (10).

19. A calibration device (14), which is designed to carry out the method according claim 11.

20. An agricultural utility vehicle (10) with the calibration device (14) according to claim 19.
